(19) United States
(12) Patent Application Publication
(10) Pub. No.: US 2024/0427059 A1
(43) Pub. Date: Dec. 26, 2024

(54) FAR-INFRARED TRANSMITTING MEMBER AND METHOD FOR MANUFACTURING FAR-INFRARED TRANSMITTING MEMBER

(71) Applicant: AGC Inc., Tokyo (JP)

(72) Inventor: Yoji YASUI, Tokyo (JP)

(73) Assignee: AGC Inc., Tokyo (JP)

(21) Appl. No.: 18/824,993

(22) Filed: Sep. 5, 2024

Related U.S. Application Data
(63) Continuation of application No. PCT/JP2023/005632, filed on Feb. 17, 2023.

(30) Foreign Application Priority Data
Mar. 7, 2022 (JP) 2022-034674

(51) Int. Cl. G02B 1/113; B60R 11/00; B60R 11/04; H04N 23/23

(52) U.S. Cl. CPC G02B 1/113; B60R 2011/0022; B60R 2011/0026; B60R 11/04; H04N 23/23

(57) ABSTRACT

To appropriately transmit far-infrared rays and improve scratch resistance. A far-infrared transmitting member (20) includes a base material (30) that transmits far-infrared rays and a first functional film (32) formed on the base material (30), in which an average transmittance for light having a wavelength of 8 μm to 12 μm is 50% or more, an outermost layer (36) of the first functional film (32) is a layer containing ZrO₂ as a main component, a content of ZrO₂ is 50 mass % or more and 100 mass % or less with respect to the whole outermost layer (36), and a refractive index of the outermost layer (36) with respect to light having a wavelength of 550 nm is 2.05 or more.

### FIELD

The present invention relates to a far-infrared transmitting member and a method for manufacturing the far-infrared transmitting member.

### BACKGROUND

For example, when a far-infrared sensor is attached to a vehicle or the like, a far-infrared transmitting member with a functional film for allowing far-infrared rays to be appropriately incident on the far-infrared sensor may be provided. For example, Patent Literature 1 describes that an infrared transmitting film containing zinc oxide as a main component and metal oxides is formed on a base material.

### CITATION LIST

### Patent Literature

Patent Literature 1: JP 2017-151408 A

### SUMMARY

### Technical Problem

Such a far-infrared transmitting member is required to improve scratch resistance while appropriately transmitting far-infrared rays.

An object of the present invention is to provide a far-infrared transmitting member capable of appropriately transmitting far-infrared rays and improving scratch resistance, and a method for manufacturing the far-infrared transmitting member.

### Solution to Problem

The far-infrared transmitting member of the present disclosure comprises: a base material that transmits far-infrared rays; and a functional film formed on the base material, wherein an average transmittance for light having a wavelength of 8 μm to 12 μm is 50% or more, and an outermost layer of the functional film is a layer containing ZrO₂ as a main component, a content of ZrO₂ is 50 mass % or more and 100 mass % or less with respect to the whole outermost layer, and a refractive index of the outermost layer with respect to light having a wavelength of 550 nm is 2.05 or more.

The method for manufacturing a far-infrared transmitting member of the present disclosure, in which a functional film is formed on a base material that transmits far-infrared rays, comprises: forming an outermost layer of the functional film on the base material by sputtering to manufacture the far-infrared transmitting member, wherein the far-infrared transmitting member has an average transmittance of 50% or more with respect to light having a wavelength of 8 μm to 12 μm, and the outermost layer is a layer containing ZrO₂ as a main component, a content of ZrO₂ is 50 mass % or more and 100 mass % or less with respect to the whole outermost layer, and a refractive index of the outermost layer with respect to light having a wavelength of 550 nm is 2.05 or more.

### Advantageous Effects of Invention

According to the present invention, far-infrared rays can be appropriately transmitted, and scratch resistance can be improved.

### BRIEF DESCRIPTION OF DRAWINGS

FIG. 1 is a schematic view illustrating a state in which a vehicle glass according to the present embodiment is mounted on a vehicle.

FIG. 2 is a schematic plan view of the vehicle glass according to the present embodiment.

FIG. 3 is a cross-sectional view taken along line A-A of FIG. 2.

FIG. 4 is a cross-sectional view taken along line B-B of FIG. 2.

FIG. 5 is a schematic cross-sectional view of a far-infrared transmitting member according to the present embodiment.

FIG. 6 is a schematic view for describing a method for manufacturing the far-infrared transmitting member according to the present embodiment.

### DESCRIPTION OF EMBODIMENTS

Hereinafter, preferred embodiments of the present invention will be described in detail with reference to the accompanying drawings. Note that the present invention is not limited by the embodiments, and in a case where there are a plurality of embodiments, the present invention includes a combination of the embodiments. Numerical values include a range of rounding.

### (Vehicle)

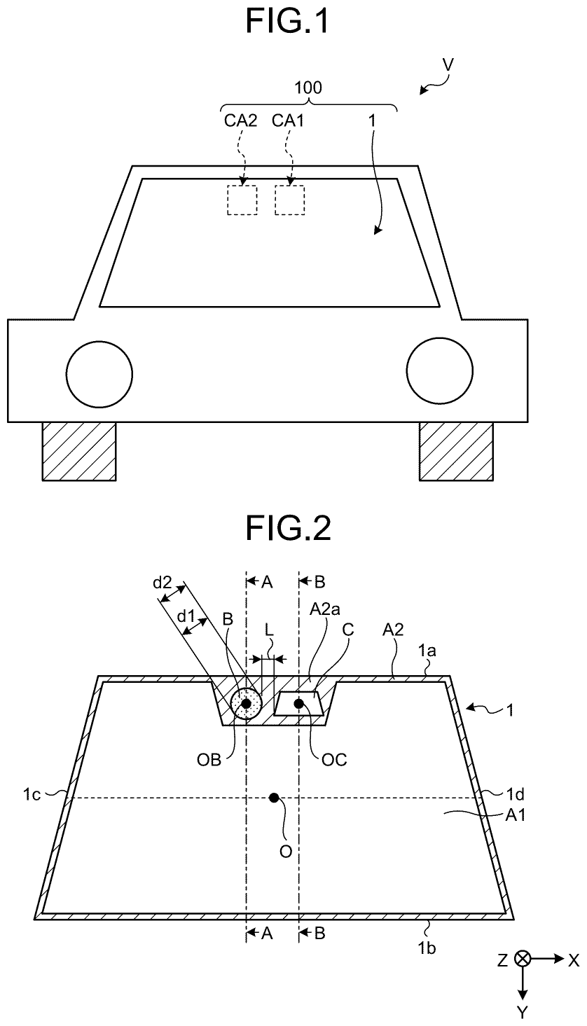

FIG. 1 is a schematic view illustrating a state in which a vehicle glass according to the present embodiment is mounted on a vehicle. As illustrated in FIG. 1, a vehicle glass 1 according to the present embodiment is mounted on a vehicle V. The vehicle glass 1 is a window member applied to a windshield of the vehicle V. That is, the vehicle glass 1 is used as the windshield of the vehicle V, in other words, as a windshield glass. A far-infrared camera CA1 and a visible light camera CA2 are mounted inside (vehicle interior) the vehicle V. The inside of the vehicle V (vehicle interior) refers to, for example, the inside of a vehicle compartment in which a driver's seat is provided.

The vehicle glass 1, the far-infrared camera CA1, and the visible light camera CA2 are included in a camera unit 100 according to the present embodiment. The far-infrared camera CA1 is a camera that detects far-infrared rays, and captures a thermal image of the outside of the vehicle V by detecting far-infrared rays from the outside of the vehicle V. The visible light camera CA2 is a camera that detects visible light, and captures an image of the outside of the vehicle V by detecting visible light from the outside of the vehicle V. The camera unit 100 may further include, for example, LiDAR or a millimeter wave radar in addition to the far-infrared camera CA1 and the visible light camera CA2. Here, the far-infrared ray is, for example, electromagnetic waves having a wavelength of 8 μm to 13 μm, and the visible light is, for example, electromagnetic waves having a wavelength of 360 nm to 830 nm. Here, the wavelength of 8 μm to 13 μm refers to a wavelength of 8 μm or more and 13 μm or less, the wavelength of 360 nm to 830 nm refers to a wavelength of 360 nm or more and 830 nm or less, and the same applies to the following. The far-infrared ray may be electromagnetic waves having a wavelength of 8 μm to 12 μm.

### (Vehicle Glass)

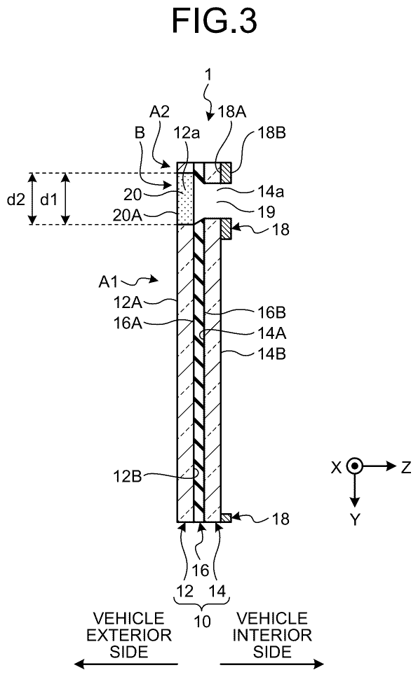

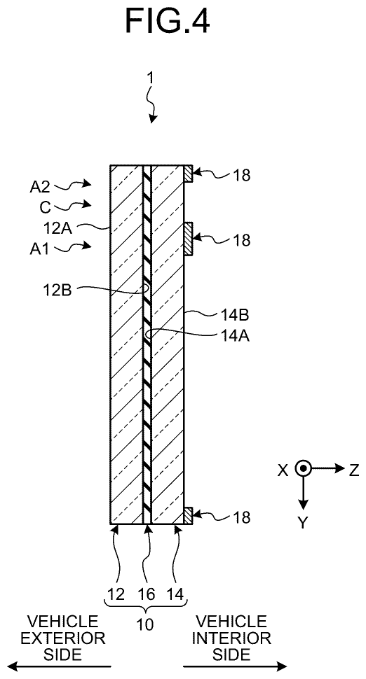

FIG. 2 is a schematic plan view of the vehicle glass according to the present embodiment. FIG. 3 is a cross-sectional view taken along line A-A of FIG. 2. FIG. 4 is a cross-sectional view taken along line B-B of FIG. 2. As illustrated in FIG. 2, hereinafter, an upper edge of the vehicle glass 1 is referred to as an upper edge portion 1a, a lower edge is referred to as a lower edge portion 1b, one side edge is referred to as a side edge portion 1c, and the other side edge is referred to as a side edge portion 1d. The upper edge portion 1a is an edge portion positioned on a vertically upper side when the vehicle glass 1 is mounted on the vehicle V. The lower edge portion 1b is an edge portion positioned on a vertically lower side when the vehicle glass 1 is mounted on the vehicle V. The side edge portion 1c is an edge portion positioned on one side when the vehicle glass 1 is mounted on the vehicle V. The side edge portion 1d is an edge portion positioned on the other side when the vehicle glass 1 is mounted on the vehicle V.

Hereinafter, among directions parallel to a surface of the vehicle glass 1, a direction from the upper edge portion 1a toward the lower edge portion 1b is referred to as a Y direction, and a direction from the side edge portion 1c toward the side edge portion 1d is referred to as an X direction. In the present embodiment, the X direction and the Y direction are orthogonal to each other. A direction orthogonal to the surface of the vehicle glass 1, that is, a thickness direction of the vehicle glass 1, is referred to as a Z direction. The Z direction is, for example, a direction from a vehicle exterior side of the vehicle V toward a vehicle interior side when the vehicle glass 1 is mounted on the vehicle V. The X direction and the Y direction are along the surface of the vehicle glass 1, but for example, in a case where the surface of the vehicle glass 1 is a curved surface, the X direction and the Y direction may be directions tangent to the surface of the vehicle glass 1 at a center point O of the vehicle glass 1. The center point O is a center position of the vehicle glass 1 when the vehicle glass 1 is viewed from the Z direction.

A light transmitting region A1 and a light shielding region A2 are formed in the vehicle glass 1. The light transmitting region A1 is a region occupying a central portion of the vehicle glass 1 when viewed from the Z direction. The light transmitting region A1 is a region for securing a visual field of a driver. The light transmitting region A1 is a region that transmits visible light. The light shielding region A2 is a region formed around the light transmitting region A1 when viewed from the Z direction. The light shielding region A2 is a region that shields visible light. In the light shielding region A2, a far-infrared transmitting region B and a visible light transmitting region C are formed in a light shielding region A2a which is a portion adjacent to the upper edge portion 1a.

The far-infrared transmitting region B is a region that transmits far-infrared rays and is a region where the far-infrared camera CA1 is provided. That is, the far-infrared camera CA1 is provided at a position overlapping the far-infrared transmitting region B when viewed from an optical axis direction of the far-infrared camera CA1. The visible light transmitting region C is a region that transmits visible light and is a region where the visible light camera CA2 is provided. That is, the visible light camera CA2 is provided at a position overlapping the visible light transmitting region C when viewed from an optical axis direction of the visible light camera CA2.

As described above, since the far-infrared transmitting region B and the visible light transmitting region C are formed in the light shielding region A2, the light shielding region A2 shields far-infrared rays in a region other than the region where the far-infrared transmitting region B is formed, and shields visible light in a region other than the region where the visible light transmitting region C is formed. The light shielding region A2a is formed around the far-infrared transmitting region B and the visible light transmitting region C. As the light shielding region A2a is provided around as described above, various sensors are protected from sunlight, which is preferable. Wiring of the various sensors is not visible from the outside of the vehicle, and thus it is preferable from the viewpoint of designability.

As illustrated in FIG. 3, the vehicle glass 1 includes a glass substrate 12 (first glass substrate), a glass substrate 14 (second glass substrate), an intermediate layer 16, and a light shielding layer 18. In the vehicle glass 1, the glass substrate 12, the intermediate layer 16, the glass substrate 14, and the light shielding layer 18 are laminated in this order in the Z direction. The glass substrate 12 and the glass substrate 14 are fixed (bonded) to each other with the intermediate layer 16 interposed therebetween.

As the glass substrates 12 and 14, for example, soda-lime glass, borosilicate glass, aluminosilicate glass, or the like can be used. The intermediate layer 16 is an adhesive layer for adhering the glass substrate 12 and the glass substrate 14. As the intermediate layer 16, for example, a polyvinyl butyral (hereinafter, also referred to as PVB)-modified material, an ethylene-vinyl acetate copolymer (EVA)-based material, a urethane resin material, a vinyl chloride resin material, or the like can be used. More specifically, the glass substrate 12 has one surface 12A and the other surface 12B and is fixed (bonded) to the intermediate layer 16 in such a way that the other surface 12B is in contact with one surface 16A of the intermediate layer 16. The glass substrate 14 has one surface 14A and the other surface 14B and is fixed (bonded) to the intermediate layer 16 in such a way that the one surface 14A is in contact with the other surface 16B of the intermediate layer 16. As described above, the vehicle glass 1 is a laminated glass in which the glass substrate 12 and the glass substrate 14 are laminated. However, the vehicle glass 1 is not limited to a laminated glass, and may include, for example, only one of the glass substrate 12 and the glass substrate 14. In this case, the intermediate layer 16 does not have to be provided either. Hereinafter, when the glass substrates 12 and 14 need not be distinguished from each other, the glass substrates 12 and 14 are referred to as a glass substrate 10.

The light shielding layer 18 has one surface 18A and the other surface 18B, and the one surface 18A is in contact with and fixed to the other surface 14B of the glass substrate 14. The light shielding layer 18 is a layer that shields visible light. As the light shielding layer 18, for example, a ceramic light shielding layer or a light shielding film can be used. As the ceramic light shielding layer, for example, a ceramic layer made of a conventionally known material such as a black ceramic layer can be used. As the light shielding film, for example, a light shielding polyethylene terephthalate (PET) film, a light shielding polyethylene naphthalate (PEN) film, a light shielding polymethyl methacrylate (PMMA) film, or the like can be used.

In the present embodiment, in the vehicle glass 1, a side on which the light shielding layer 18 is provided is an interior side (vehicle interior side) of the vehicle V, and a side on which the glass substrate 12 is provided is an exterior side (vehicle exterior side) of the vehicle V. However, the present invention is not limited thereto, and the light shielding layer 18 may be provided on the exterior side of the vehicle V. In a case where the glass substrates 12 and 14 are implemented by laminated glasses, the light shielding layer 18 may be formed between the glass substrate 12 and the glass substrate 14.

### (Light Shielding Region)

The light shielding region A2 is formed by providing the light shielding layer 18 on the glass substrate 10. That is, the light shielding region A2 is a region in which the glass substrate 10 includes the light shielding layer 18. That is, the light shielding region A2 is a region in which the glass substrate 12, the intermediate layer 16, the glass substrate 14, and the light shielding layer 18 are laminated. On the other hand, the light transmitting region A1 is a region in which the glass substrate 10 does not include the light shielding layer 18. That is, the light transmitting region A1 is a region in which the glass substrate 12, the intermediate layer 16, and the glass substrate 14 are laminated and the light shielding layer 18 is not laminated.

### (Far-Infrared Transmitting Region)

As illustrated in FIG. 3, the vehicle glass 1 has an opening portion 19 penetrating from one surface (here, the surface 12A) to the other surface (here, the surface 14B) in the Z direction. A far-infrared transmitting member 20 is provided in the opening portion 19. A region where the opening portion 19 is formed and the far-infrared transmitting member 20 is provided is the far-infrared transmitting region B. That is, the far-infrared transmitting region B is a region where the opening portion 19 and the far-infrared transmitting member 20 arranged in the opening portion 19 are provided. Since the light shielding layer 18 does not transmit far-infrared rays, the light shielding layer 18 is not provided in the far-infrared transmitting region B. That is, in the far-infrared transmitting region B, the glass substrate 12, the intermediate layer 16, the glass substrate 14, and the light shielding layer 18 are not provided, and the far-infrared transmitting member 20 is provided in the formed opening portion 19. The far-infrared transmitting member 20 will be described below.

### (Visible Light Region)

As illustrated in FIG. 4, the visible light transmitting region C is a region in which the glass substrate 10 does not include the light shielding layer 18 in the Z direction, similarly to the light transmitting region A1. That is, the visible light transmitting region C is a region where the glass substrate 12, the intermediate layer 16, and the glass substrate 14 are laminated, and the light shielding layer 18 is not laminated.

As illustrated in FIG. 2, the visible light transmitting region C is preferably provided in the vicinity of the far-infrared transmitting region B. Specifically, the center of the far-infrared transmitting region B when viewed from the Z direction is defined as a center point OB, and the center of the visible light transmitting region C when viewed from the Z direction is defined as a center point OC. When the shortest distance between the far-infrared transmitting region B (opening portion 19) and the visible light transmitting region C when viewed from the Z direction is defined as a distance L, the distance L is preferably more than 0 mm and 100 mm or less, and more preferably 10 mm or more and 80 mm or less. As the visible light transmitting region C is positioned within the range from the far-infrared transmitting region B, the far-infrared camera CA1 and the visible light camera CA2 can capture images of close positions, and it is possible to appropriately capture an image by the visible light camera CA2 while suppressing the amount of perspective distortion in the visible light transmitting region C. As the far-infrared camera CA1 and the visible light camera CA2 capture images of close positions, a load at the time of executing arithmetic processing on data obtained from each camera is reduced, and handling of a power supply and a signal cable also becomes suitable.

As illustrated in FIG. 2, the visible light transmitting region C and the far-infrared transmitting region B are preferably positioned side by side in the X direction. That is, it is preferable that the visible light transmitting region C is not positioned on a Y direction side of the far-infrared transmitting region B and is arranged side by side with the far-infrared transmitting region B in the X direction. As the visible light transmitting region C is arranged side by side with the far-infrared transmitting region B in the X direction, the visible light transmitting region C can be arranged in the vicinity of the upper edge portion 1a. Therefore, a visual field of the driver in the light transmitting region A1 can be appropriately secured.

### (Far-Infrared Transmitting Member)

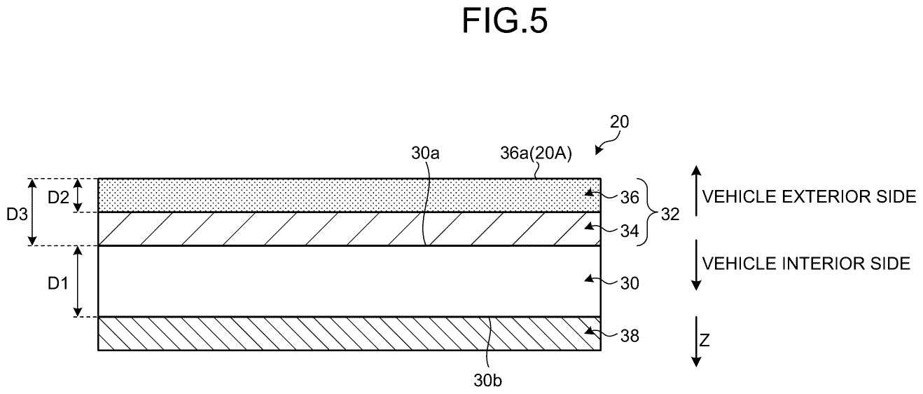

Hereinafter, the far-infrared transmitting member 20 provided in the far-infrared transmitting region B will be specifically described. FIG. 5 is a schematic cross-sectional view of the far-infrared transmitting member according to the present embodiment. As illustrated in FIG. 5, the far-infrared transmitting member 20 includes a base material 30, a first functional film 32 serving as a functional film formed on the base material 30, and a second functional film 38 formed on the base material 30. In the present embodiment, the first functional film 32 is formed on one surface 30a of the base material 30. The surface 30a is a surface on the vehicle exterior side when mounted on the vehicle glass 1. The second functional film 38 is formed on the other surface 30b of the base material 30. The surface 30b is a surface on the vehicle interior side when mounted on the vehicle glass 1. However, the second functional film 38 is not an essential component, and a layer other than the base material 30 does not have to be provided on the surface 30b.

In the present embodiment, the far-infrared transmitting member 20 is provided in the light shielding region A2 of the vehicle glass 1 which is a window member of the vehicle V, but the present invention is not limited thereto. The far-infrared transmitting member 20 may be provided in any exterior member of the vehicle V such as an exterior member for a pillar of the vehicle V. Further, the far-infrared transmitting member 20 is not limited to be provided in the vehicle V, and may be used for any purpose.

### (Base Material)

The base material 30 is a member that can transmit far-infrared rays. The base material 30 has an internal transmittance of preferably 50, or more, more preferably 60% or more, and still more preferably 70% or more with respect to light having a wavelength of 10 μm (far-infrared rays). In addition, the base material 30 has an average internal transmittance of preferably 50% or more, more preferably 60% or more, and still more preferably 70% or more with respect to light having a wavelength of 8 μm to 12 μm (far-infrared rays). As the internal transmittance of the base material at 10 μm and the average internal transmittance of the base material 30 at 8 μm to 12 μm fall within the numerical ranges, far-infrared rays can be appropriately transmitted, and for example, the performance of the far-infrared camera CA1 can be sufficiently exhibited. Here, the average internal transmittance is an average value of internal transmittances with respect to the light of each wavelength in the wavelength band (here, 8 μm to 12 μm).

The internal transmittance of the base material 30 is a transmittance excluding surface reflection losses on an incident side and an emission side, and is well known in the art. The internal transmittance may be measured by a general method. The measurement is performed, for example, as follows.

A pair of plate-like samples (a first sample and a second sample) made of a base material having the same composition and having different thicknesses is prepared. The plate-like sample has optically polished flat opposite surfaces that are parallel to each other. Assuming that an external transmittance including a surface reflection loss of the first sample is T1, an external transmittance including a surface reflection loss of the second sample is T2, the thickness of the first sample is Td1 (mm), and the thickness of the second sample is Td2 (mm), where Td1<Td2, an internal transmittance τ at a thickness Tdx (mm) can be calculated by the following Equation (1).

$$τ = exp [ - Tdx \times ( ln T 1 - ln T 2 ) / Δ Td ] \qquad ( 1 )$$

An external transmittance of infrared rays can be measured by, for example, a Fourier transform infrared spectrometer (product name: Nicolet iS10 manufactured by ThermoScientific).

The base material 30 has a refractive index of preferably 1.5 or more and 4.0 or less, more preferably 2.0 or more and 4.0 or less, and still more preferably 2.2 or more and 3.5 or less with respect to light having a wavelength of 10 μm. The base material 30 has an average refractive index of preferably 1.5 or more and 4.0 or less, more preferably 2.0 or more and 4.0 or less, and still more preferably 2.2 or more and 3.5 or less with respect to light having a wavelength of 8 μm to 12 μm. As the refractive index or average refractive index of the base material 30 falls within the numerical range, far-infrared rays can be appropriately transmitted, and for example, the performance of the far-infrared camera CA1 can be sufficiently exhibited. Here, the average refractive index is an average value of refractive indexes with respect to the light of each wavelength in the wavelength band (here, 8 μm to 12 μm). The refractive index can be determined by performing fitting of an optical model using, for example, polarization information obtained by an infrared spectroscopic ellipsometer (IR-VASE-UT manufactured by J.A. Woollam) and a spectral transmission spectrum obtained by a Fourier transform infrared spectrometer.

A thickness D1 of the base material 30 is preferably 0.5 mm or more and 5 mm or less, more preferably 1 mm or more and 4 mm or less, and still more preferably 1.5 mm or more and 3 mm or less. As the thickness D1 is within the range, far-infrared rays can be appropriately transmitted while ensuring strength. The thickness D1 can also be said to be a length from the surface 30a to the surface 30b of the base material 30 in the Z direction.

A material of the base material 30 is not particularly limited, and examples thereof include Si, Ge, ZnS, and chalcogenide glass. It can be said that the base material 30 preferably contains at least one material selected from the group consisting of Si, Ge, ZnS, and chalcogenide glass. As such a material is used for the base material 30, far-infrared rays can be appropriately transmitted.

A preferable composition of the chalcogenide glass is a composition containing,
in atoms,
7% to 25% of Ge+Ga,
0% to 35% of Sb,
0% to 20% of Bi,
0% to 20% of Zn,
0% to 20% of Sn,
0% to 20% of Si,
0% to 20% of La,
55% to 80% of S+Se+Te,
0.005% to 0.3% of Ti,
0% to 20% of Li+Na+K+Cs, and
0% to 20% of F+Cl+Br+I. The glass preferably has a glass transition point (Tg) of 140° C. to 550° C.

Si or ZnS is more preferably used as the material of the base material 30.

### (First Functional Film)

The first functional film 32 is formed on the surface 30a of the base material 30 on the vehicle exterior side. The first functional film 32 includes an intermediate layer 34 and an outermost layer 36. The outermost layer 36 is a layer provided at a position farthest from the base material 30 in the first functional film 32, that is, at a position that is the most adjacent to the vehicle exterior side in the present embodiment. In other words, the outermost layer 36 is the outermost layer (a layer that is the most adjacent to the vehicle exterior side in the present embodiment) of the far-infrared transmitting member 20 and is exposed to the outside.

The intermediate layer 34 is a layer provided closer to the base material 30 than the outermost layer 36 is (closer to the vehicle interior side than the outermost layer 36 is in the present embodiment) in the first functional film 32. That is, the intermediate layer 34 is provided between the base material 30 and the outermost layer 36. However, the first functional film 32 does not have to include the intermediate layer 34, and may include only the outermost layer 36.

### (Outermost Layer)

The outermost layer 36 is a layer containing ZrO₂ as a main component. Here, the main component may indicate that a content with respect to the whole outermost layer 36 is 50 mass % or more. In the outermost layer 36, the content of ZrO₂ is 50 masse % or more and 100 mass % or less, preferably 70 mass % or more and 100 mass % or less, and more preferably 90 mass % or more and 100 mass % or less with respect to the whole outermost layer 36. In the outermost layer 36, the content of ZrO₂ alone except for inevitable impurities is preferably 100 mass %. As the content of ZrO₂ falls within the range, the outermost layer 36 can appropriately transmit far-infrared rays and improve scratch resistance.

The outermost layer 36 may contain an accessory component that is a component other than ZrO₂ as a main component. The accessory component is preferably an oxide that transmits far-infrared rays, and examples thereof include at least one of NiOₓ, ZnO, Bi₂O₃, or CuOₓ.

A thickness D2 of the outermost layer 36 is preferably 20 nm or more, more preferably 50 nm or more and 300 nm or less, still more preferably 100 nm or more and 300 nm or less, and most preferably 150 nm or more and 250 nm or less. The thickness D2 can also be said to be a length from a Z direction side surface of the outermost layer 36 to a surface opposite thereof in the Z direction.

A ratio of the thickness D2 of the outermost layer 36 to the thickness D1 of the base material 30 is preferably 0.002% or more and 0.030% or less, more preferably 0.005% or more and 0.020% or less, and still more preferably 0.008% or more and 0.013% or less.

A ratio of the thickness D2 of the outermost layer 36 to a thickness D3 of the first functional film 32 is preferably 1% or more and 25% or less, more preferably 3% or more and 25% or less, still more preferably 5% or more and 25% or less, and most preferably 7% or more and 21% or less. The thickness D3 of the first functional film 32 can also be said to be a length from a Z direction side surface of the first functional film 32 to a surface opposite thereto in the Z direction.

When the thickness D2 is within the range, far-infrared rays can be appropriately transmitted, and the scratch resistance can be appropriately improved.

A surface of the outermost layer 36 on a side opposite to the base material 30 is defined as a surface 36a. The surface 36a is a surface on a side exposed to the outside, and can be said to be a surface on the vehicle exterior side in the present embodiment. In this case, an arithmetic average roughness Ra (surface roughness) of the surface 36a of the outermost layer 36 is preferably 7.0 nm or less, more preferably 5.0 nm or less, still more preferably 4.0 nm or less, and most preferably 3.0 nm or less. As the arithmetic average roughness Ra of the surface 36a falls within the range, a dynamic friction coefficient and a change in surface roughness before and after scratching can be reduced, thereby more appropriately improving the scratch resistance. The arithmetic average roughness Ra refers to an arithmetic average roughness Ra defined in JIS B 0601:2001.

The outermost layer 36 can transmit far-infrared rays. The outermost layer 36 has an extinction coefficient of preferably 0.10 or less, more preferably 0.05 or less, and still more preferably 0.04 or less with respect to light having a wavelength of 10 μm. The extinction coefficient can be determined by performing fitting of an optical model using, for example, polarization information obtained by an infrared spectroscopic ellipsometer (IR-VASE-UT manufactured by J.A. Woollam) and a spectral transmission spectrum obtained by a Fourier transform infrared spectrometer.

The outermost layer 36 has a refractive index of preferably 2.05 or more, more preferably 2.05 or more and 2.40 or less, still more preferably 2.10 or more and 2.30 or less, and particularly preferably 2.15 or more and 2.25 or less with respect to light having a wavelength of 550 nm (visible light). As the refractive index of the outermost layer 36 with respect to visible light falls within the numerical range, a film denseness of the outermost layer 36 can be increased, and the scratch resistance can be more appropriately improved. The refractive index for light having a wavelength of 550 nm can be determined by performing fitting of an optical model using, for example, polarization information obtained by a spectroscopic ellipsometer (M-2000 manufactured by J.A. Woollam) and a spectral transmittance measured based on JIS R3106.

### (Intermediate Layer)

The intermediate layer 34 can transmit far-infrared rays. In the example of the present embodiment, the intermediate layer 34 includes an antireflection layer. In the following description, an example in which the intermediate layer 34 includes only one antireflection layer will be described, but the present invention is not limited thereto, and the intermediate layer 34 may be formed by laminating a plurality of layers.

### (Antireflection Layer)

The antireflection layer included in the intermediate layer 34 is a layer containing NiO_{X} as a main component. Here, the main component may indicate that a content with respect to the whole antireflection layer is 50 mass % or more. In the antireflection layer, the content of NiO_{X} is 50 mass % or more and 100 mass % or less, preferably 70 mass % or more and 100 mass % or less, and more preferably 90 mass, or more and 100 mass % or less with respect to the whole antireflection layer. In the antireflection layer, the content of NiO_{X} alone except for inevitable impurities is preferably 100 mass %. As the content of NiO_{X} falls within the range, reflection of far-infrared rays can be suppressed and far-infrared rays can be appropriately transmitted through the antireflection layer.

It is known that nickel oxide has a plurality of compositions according to the valence of nickel, and X can be any value from 0.5 to 2. The valence does not have to be a single valence, and two or more valences may be mixed. In the present embodiment, NiO is preferably used as NiOₓ. However, a material of the antireflection layer is not limited thereto and may be any material, and the antireflection layer may be, for example, a layer containing at least one of ZnS, Ge, Si, MgO, ZnO, or Bi₂O₃.

A thickness of the antireflection layer included in the intermediate layer 34 is preferably 1000 nm or more and 2000 nm or less, more preferably 1000 nm or more and 1500 nm or less, and still more preferably 1100 nm or more and 1300 nm or less. A ratio of the thickness of the antireflection layer to the thickness D2 of the outermost layer 36 is preferably 75% or more and 99% or less, more preferably 75% or more and 97% or less, still more preferably 75% or more and 95% or less, and most preferably 79% or more and 93% or less. As the thickness of the antireflection layer falls within the range, reflection of far-infrared rays can be suppressed, and far-infrared rays can be appropriately transmitted. The thickness of the antireflection layer can also be said to be the length from a Z direction side surface of the antireflection layer to a surface opposite thereto in the Z direction.

The antireflection layer included in the intermediate layer 34 can transmit far-infrared rays. The antireflection layer has an extinction coefficient of preferably 0.05 or less, more preferably 0.03 or less, still more preferably 0.02 or less, and most preferably 0.01 or less with respect to light having a wavelength of 10 μm. As the extinction coefficient falls within the range, far-infrared rays can be appropriately transmitted.

The antireflection layer included in the intermediate layer 34 has an extinction coefficient of preferably 0.04 or more, more preferably 0.06 or more, still more preferably 0.08 or more, and most preferably 0.10 or more with respect to light (visible light) having a wavelength of 550 nm. As the extinction coefficient of the antireflection layer with respect to visible light falls within the range, it is possible to appropriately suppress reflectance dispersion of visible light and obtain an appearance securing designability.

### (Color Adjustment Layer)

As described above, the intermediate layer 34 may further include a layer other than the antireflection layer. In this case, for example, the intermediate layer 34 may include a color adjustment layer that is provided more adjacent to the outermost layer 36 than the antireflection layer is. That is, in this case, it can be said that the base material 30, the antireflection layer, the color adjustment layer, and the outermost layer 36 may be laminated in this order toward the vehicle exterior side. Hereinafter, the color adjustment layer will be specifically described.

The color adjustment layer included in the intermediate layer 34 is a layer for securing designability by reducing a difference in reflectance (reflectance dispersion) with respect to visible light having different wavelengths and suppressing an interference color of the far-infrared transmitting member 20.

The color adjustment layer included in the intermediate layer 34 can transmit far-infrared rays. The color adjustment layer has an extinction coefficient of preferably 0.4 or less, more preferably 0.2 or less, and still more preferably 0.1 or less with respect to light having a wavelength of 10 μm. As the extinction coefficient falls within the range, far-infrared rays can be appropriately transmitted.

A thickness of the color adjustment layer included in the intermediate layer 34 is preferably 5 nm or more and 100 nm or less, more preferably 10 nm or more and 60 nm or less, and still more preferably 20 nm or more and 50 nm or less. A ratio of a thickness of the color adjustment layer to the thickness D2 of the outermost layer 36 is preferably 2.5% or more and 100% or less, more preferably 5, or more and 50% or less, still more preferably 10% or more and 30% or less, and most preferably 10% or more and 25% or less. As the thickness of the color adjustment layer falls within the range, it is possible to suppress reflectance dispersion for visible light while appropriately transmitting far-infrared rays, thereby making the far-infrared transmitting member 20 inconspicuous. The thickness of the color adjustment layer can also be said to be a length from a Z direction side surface of the color adjustment layer to a surface opposite thereto in the Z direction.

In the present embodiment, the color adjustment layer included in the intermediate layer 34 includes a first layer and a second layer that is provided more adjacent to the outermost layer 36 (vehicle exterior side) than the first layer is.

In the present embodiment, the first layer is a layer formed of the same material and having the same characteristic as the outermost layer 36. However, a thickness of the first layer is preferably 10 nm or more and 40 nm or less, more preferably 15 nm or more and 35 nm or less, and still more preferably 20 nm or more and 30 nm or less. A ratio of the thickness of the first layer to the thickness D2 of the outermost layer 36 is preferably 1.5% or more and 60% or less, more preferably 3% or more and 30% or less, still more preferably 6% or more and 20% or less, and most preferably 6, or more and 15% or less.

In the present embodiment, the second layer is a layer formed of the same material and having the same characteristic as the antireflection layer included in the intermediate layer 34. However, a thickness of the second layer is preferably 5 nm or more and 40 nm or less, more preferably 5 nm or more and 25 nm or less, and still more preferably 10 nm or more and 20 nm or less. A ratio of the thickness of the second layer to the thickness D2 of the outermost layer 36 is preferably 1% or more and 40% or less, more preferably 2% or more and 20% or less, still more preferably 4% or more and 12% or less, and most preferably 4% or more and 10% or less.

In this example, the color adjustment layer includes two layers of the first layer and the second layer, but is not limited thereto, and a laminate of the first layer and the second layer may be laminated in a plurality of layers. The color adjustment layer is preferably a layer in which 2n (n is a natural number of 1 or more) layers of the first layer and the second layer are alternately laminated from a base material 30 side. A layer having a low refractive index with respect to light (visible light) having a wavelength of 550 nm preferably has a higher film thickness ratio in the color adjustment layer. As the order of lamination and the number of layers of the color adjustment layer fall within the ranges, reflectance dispersion for visible light can be suppressed, thereby making the far-infrared transmitting member 20 inconspicuous.

However, the configuration of the color adjustment layer is not limited to one including the first layer of the same material as the outermost layer 36 and the second layer of the same material as the antireflection layer, and may be any configuration. That is, the color adjustment layer may be a layer having a refractive index different from those of the outermost layer 36 and the antireflection layer with respect to light (visible light) having a wavelength of 550 nm. The color adjustment layer has a refractive index of preferably 2.2 or more and 2.5 or less, and more preferably 2.3 or more and 2.4 or less with respect to light having a wavelength of 550 nm (visible light). As the refractive index of the color adjustment layer with respect to visible light falls within the numerical range, reflectance dispersion for visible light can be suppressed, thereby making the far-infrared transmitting member 20 inconspicuous.

### (Second Functional Film)

The second functional film 38 provided on the surface 30b of the base material 30 on the vehicle interior side is a layer that transmits far-infrared rays. The second functional film 38 may have the same configuration as the intermediate layer 34. That is, for example, in the far-infrared transmitting member 20, the base material 30 and the antireflection layer may be laminated in this order from the base material 30 toward the vehicle interior side. In addition, for example, the far-infrared transmitting member 20 may include the base material 30, the antireflection layer, and the color adjustment layer (the first layer and the second layer) laminated in this order from the base material 30 toward the vehicle interior side.

### (Adhesive Film)

An adhesion layer (not illustrated) may be formed between the intermediate layer 34 and the base material 30. The adhesive film is a film that bonds the base material 30 and the intermediate layer 34 to each other, in other words, a film that improves an adhesive strength between the base material 30 and the intermediate layer 34.

The adhesive film has a refractive index of preferably 1.0 or more and 4.3 or less, more preferably 1.5 or more and 4.3 or less, and still more preferably 1.5 or more and 3.8 or less with respect to light having a wavelength of 10 μm. As the refractive index falls within the range, reflection of far-infrared rays can be appropriately suppressed.

A thickness of the adhesive film is preferably 0.05 μm or more and 0.5 μm or less, more preferably 0.05 μm or more and 0.3 μm or less, and still more preferably 0.05 μm or more and 0.1 μm or less. As the thickness of the adhesive film is in the range, the base material 30 and the intermediate layer 34 can be appropriately bonded to each other while appropriately suppressing reflection of far-infrared rays. The thickness of the adhesive film can also be said to be the length from a Z direction side surface of the adhesive film to a surface opposite thereto in the Z direction. In addition, the thickness of the adhesive film is preferably smaller than the thickness of the intermediate layer 34 and the thickness D2 of the outermost layer 36. Since the thickness of the adhesive film is smaller than the thicknesses of these layers, an influence on optical performance can be reduced.

The adhesive film can transmit far-infrared rays. The adhesive film has an extinction coefficient of preferably 0.4 or less, more preferably 0.2 or less, and still more preferably 0.1 or less with respect to light having a wavelength of 10 μm. As the extinction coefficient falls within the range, far-infrared rays can be appropriately transmitted.

A material of the adhesive film is arbitrary, but for example, it is preferable to contain at least one material selected from the group consisting of Si, Ge, MgO, NiOₓ, CuOₓ, ZnS, Al₂O₃, ZrO₂, SiO₂, TiO₂, ZnO, and Bi₂O₃, and it is more preferable to contain ZrO₂. The base material 30 and the intermediate layer 34 can be appropriately bonded to each other by using such a material for the adhesive film.

Similarly to the intermediate layer 34, the adhesive film may be formed by sputtering, but is not limited thereto, and may be formed by vapor deposition, for example.

### (Characteristics of Far-Infrared Transmitting Member)

As described above, in the far-infrared transmitting member 20, the first functional film 32 including the outermost layer 36 is formed on the surface 30a of the base material 30. By forming the outermost layer 36, the far-infrared transmitting member 20 can appropriately improve the scratch resistance while appropriately transmitting far-infrared rays.

The far-infrared transmitting member 20 has an internal transmittance of preferably 50% or more, more preferably 65% or more, and still more preferably 70% or more with respect to light of 10 μm. In addition, the far-infrared transmitting member 20 has an average internal transmittance of preferably 50% or more, more preferably 65% or more, and still more preferably 70% or more with respect to light having a wavelength of 8 μm to 12 μm. As the transmittance and the average transmittance fall within the ranges, a function as an infrared transmitting member can be appropriately exhibited.

The far-infrared transmitting member 20 has a reflectance of preferably 15% or less, more preferably 10% or less, and still more preferably 5% or less with respect to light of 10 μm. The far-infrared transmitting member 20 has an average reflectance of preferably 15% or less, more preferably 10% or less, and still more preferably 5% or less with respect to light having a wavelength of 8 μm to 12 μm. As the reflectance and the average reflectance fall within the ranges, the function as the infrared transmitting member can be appropriately exhibited. Here, the average internal transmittance is an average value of internal transmittances with respect to light having each wavelength in the wavelength band (here, 8 μm to 12 μm). The reflectance can be measured by, for example, a Fourier transform infrared spectrometer (Nicolet iS10 manufactured by ThermoScientific).

In the far-infrared transmitting member 20, an indentation hardness of a surface 20A on the vehicle exterior side (that is, the surface 36a of the outermost layer 36) in a range of an indentation depth of 90 nm or more and 110 nm or less is preferably 9.0 GPa or more, more preferably 10.0 GPa or more, still more preferably 11.0 GPa or more, particularly preferably 12.0 GPa or more, and most preferably 13.0 GPa or more. As the indentation hardness of the surface 20A falls within the range, the scratch resistance can be appropriately improved.

The indentation hardness of the surface 20A refers to an indentation hardness in the range of the indentation depth of 90 nm or more and 110 nm or less as measured by a nanoindentation method (continuous stiffness measurement method) using a nanoindenter. More specifically, the indentation hardness is a value obtained from a displacement-load curve from loading to unloading of the measurement indenter, and is defined in ISO 14577.

The indentation hardness can be measured as follows. Specifically, an indentation depth h (nm) corresponding to an indentation load P (mN) is continuously measured using an iMicro nanoindenter manufactured by KLA over the entire process from the start of loading to unloading at a measurement site, and a P-h curve is created. Then, the indentation hardness H (GPa) is calculated from the created P-h curve as in the following Equation (2).

$$H = P / A \qquad ( 2 )$$

In Equation (2), P is the indentation load (mN), and A is a projected area (μm²) of the indenter.

In the present embodiment, the indentation hardness H in a section where the indentation depth is 90 nm or more and 110 nm or less is defined as the indentation hardness of the surface 20A. That is, in the present embodiment, it can be said that it is preferable that the indentation hardness H satisfies the above range in the entire section having the indentation depth of 90 nm or more and 110 nm or less.

In the far-infrared transmitting member 20, Δa*b* is preferably 5 or less, more preferably 4 or less, still more preferably 3 or less, particularly preferably 2 or less, and most preferably 1 or less. Δa*b* refers to a distance between origin coordinates and of a*b* in a CIE-Lab color system obtained from 5-degree incident visible light reflection spectrum. That is, Δa*b* is calculated by the following Equation (3). As Δa*b* falls within the range, visible light reflected from the far-infrared transmitting member 20 has a neutral color, so that an appearance securing designability can be obtained.

$$Δ {a}^{⋆} {b}^{⋆} = {( {a}^{* 2} + {b}^{* 2} )}^{0.5} \qquad ( 3 )$$

a* and b* are chromaticity coordinates of reflected light in the CIE-Lab color system when a standard illuminant D65 is used for illumination light, and can be calculated based on JIS Z 8781-4 using a spectral reflectance measured based on JIS R3106.

In particular, when the far-infrared transmitting member 20 includes a NiOₓ film whose extinction coefficient in a visible range changes depending on the degree of oxidation, it is possible to suppress a change in a* and b* accompanying a change in degree of oxidation of the NiOₓ film in a moisture resistance test, a water resistance test, or a heat resistance test.

As illustrated in FIG. 3, the far-infrared transmitting member 20 is preferably formed in such a way that the surface 20A on the vehicle exterior side is flush (continuous) with a surface of the light shielding region A2 on the vehicle exterior side. In other words, the surface 20A of the far-infrared transmitting member 20 on the vehicle exterior side is attached in such a way as to be continuous with the surface 12A of the glass substrate 12. As described above, the surface 20A of the far-infrared transmitting member 20 is continuous with the surface 12A of the glass substrate 12, so that a wiping effect of the wiper can be suppressed from being impaired. In addition, it is possible to suppress a risk that the design of the vehicle V is impaired due to the presence of a step, or dust or the like accumulates on the step. Furthermore, the far-infrared transmitting member 20 is preferably molded in accordance with a curved surface shape of the applied vehicle glass 1. A method for molding the far-infrared transmitting member 20 is not particularly limited, but polishing or molding is selected according to the curved surface shape or the member.

The shape of the far-infrared transmitting member 20 is not particularly limited, but is preferably a plate-like shape matching the shape of the opening portion 19. That is, for example, when the opening portion 19 is circular, the far-infrared transmitting member 20 preferably has a disk shape (cylindrical shape). In addition, from the viewpoint of designability, the surface of the far-infrared transmitting member 20 on the vehicle exterior side may be processed to have a shape matching a curvature of an outer surface shape of the glass substrate 12. Furthermore, the far-infrared transmitting member 20 may have a lens shape for the reason of achieving both an increase in viewing angle of the far-infrared camera CA1 and improvement of mechanical characteristics. Such a configuration is preferable because far-infrared light can be efficiently condensed even if the area of the far-infrared transmitting member 20 is small. In this case, the number of lens-shaped far-infrared transmitting members 20 is preferably one to three, and typically preferably two. Further, it is particularly preferable that the lens-shaped far-infrared transmitting member 20 is aligned in advance and modularized, and is integrated with a housing or a bracket for bonding the far-infrared camera CA1 to the vehicle glass 1.

In the vehicle glass 1 of the present embodiment, it is preferable that an area of the opening portion 19 on the surface on the vehicle interior side is smaller than an area of the opening portion 19 on the surface on the vehicle exterior side, and the area of the far-infrared transmitting member 20 on the surface on the vehicle interior side is also smaller than an area of the far-infrared transmitting member 20 on the surface on the vehicle exterior side. With such a configuration, strength against an impact from the outside of the vehicle is improved. Furthermore, in a case where the vehicle glass 1 of the present embodiment is a laminated glass including the glass substrate 12 (vehicle exterior side) and the glass substrate 14 (vehicle interior side), the opening portion 19 is formed in such a way that an opening portion 12a of the glass substrate 12 and an opening portion 14a of the glass substrate 14 overlap each other. In this case, it is sufficient if the area of the opening portion 12a of the glass substrate 12 is made larger than the area of the opening portion 14a of the glass substrate 14, and the far-infrared transmitting member 20 having a size matching the size of the opening portion 12a of the glass substrate 12 is arranged in the opening portion 12a of the glass substrate 12.

In addition, as illustrated in FIG. 3, in the far-infrared transmitting member 20, a length d1 of the longest straight line among straight lines connecting arbitrary two points in the surface on the vehicle exterior side is preferably 80 mm or less. The length d1 is more preferably 70 mm or less, and still more preferably 65 mm or less. Further, the length d1 is preferably 60 mm or more. In addition, as illustrated in FIG. 3, in the opening portion 19 of the far-infrared transmitting region B, a length d2 of the longest straight line among straight lines connecting arbitrary two points in the surface on the vehicle exterior side is preferably 80 mm or less. The length d2 is more preferably 70 mm or less, and still more preferably 65 mm or less. Further, the length d2 is preferably 60 mm or more. The length d2 can also be said to be a length of the longest straight line among straight lines connecting arbitrary two points on an outer periphery of the opening portion 19 in the surface (surface 12A) of the vehicle glass 1 on the vehicle exterior side. As the length d1 of the far-infrared transmitting member 20 and the length d2 of the opening portion 19 are set within the ranges, it is possible to suppress a decrease in strength of the vehicle glass 1 and also suppress the amount of perspective distortion around the opening portion 19. The lengths d1 and d2 are lengths corresponding to a diameter of the surface on the vehicle exterior side in a case where the shape of the surface of the far-infrared transmitting member 20 on the vehicle exterior side is circular. In addition, the lengths d1 and d2 here indicate lengths in a state where the vehicle glass 1 is mounted on the vehicle V. For example, in a case where the glass is subjected to bending and mounted on the vehicle V, the lengths d1 and d2 are lengths after the bending. The same applies to the description of dimensions and positions other than the lengths d1 and d2 unless otherwise specified.

### (Method for Manufacturing Far-Infrared Transmitting Member)

Next, a method for manufacturing the far-infrared transmitting member 20 will be described. When manufacturing the far-infrared transmitting member 20, the base material 30 is prepared, and the first functional film 32 is formed on the surface of the base material 30. Any method can be used for forming the first functional film 32, and in the present embodiment, the first functional film 32 is formed on the surface of the base material 30 by sputtering. That is, in the example of the present embodiment, the intermediate layer 34 is formed on the surface of the base material 30 by sputtering. Then, the outermost layer 36 is formed on the surface of the base material 30, that is, the surface of the intermediate layer 34 here, by sputtering. In this manner, the far-infrared transmitting member 20 is manufactured. By forming the first functional film 32 by sputtering, adhesion of the film can be improved. In the present embodiment, the second functional film 38 is formed on the surface of the base material 30 on a side opposite to the first functional film 32 by sputtering.

Any method may be used for sputtering, for example, a reactive sputtering method or a post-oxidation sputtering method may be used, and it is preferable to use the post-oxidation sputtering method.

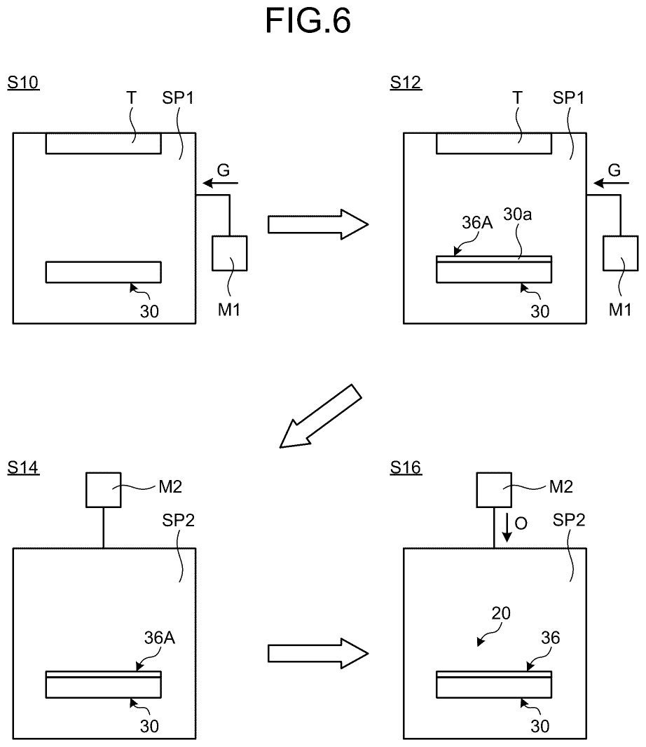

FIG. 6 is a schematic view for describing the method for manufacturing the far-infrared transmitting member according to the present embodiment. Hereinafter, a case where the outermost layer 36 is directly formed on the base material 30 will be described as an example, but in a case where the outermost layer 36 is formed on the intermediate layer 34, the same method as that in the following can be applied except that the base material 30 having the surface on which the outermost layer 36 is formed is used.

As illustrated in FIG. 6, in the post-oxidation sputtering method, the base material 30 is arranged in a first space SP1 (step S10). A target T is provided in the first space SP1, and an inert gas supply unit M1 is connected to the first space SP1. The target T is a member serving as a raw material of the outermost layer 36 laminated on the base material 30. The base material 30 is arranged in the first space SP1 such that the surface 30a on a side where the outermost layer 36 is formed faces the target T. The inert gas supply unit M1 is a device that supplies inert gas G into the first space SP1, and creating an inert gas G atmosphere in the first space SP1. Argon is used as the inert gas G, but the inert gas G is not limited thereto, and for example, a rare gas other than argon may be used.

After the base material 30 is arranged in the first space SP1, the inert gas G is introduced into the first space SP1 in which the target T and the base material 30 are arranged, so that sputtering is performed to laminate Zr contained in the target T on the surface 30a of the base material 30 (step S12 (lamination step)). Specifically, in this step, the inert gas G is introduced from the inert gas supply unit M1 into the first space SP1 in a state where a vacuum state is made in the first space SP1. Then, by applying a negative voltage to the target T, the inert gas G is ionized, and the ionized inert gas G collides with the surface of the base material 30. As a result, components (atoms and molecules) contained in the target T, here, Zr contained in the target T, are ejected from the target T and laminated on the surface 30a of the base material 30. A laminate containing Zr laminated on the surface 30a of the base material 30 is hereinafter referred to as a laminate 36A.

The component ejected from the target T and laminated as the laminate 36A is not limited to Zr, and other components (for example, ZrO₂) such as atoms and molecules contained in the target T may also be ejected from the target T and laminated as the laminate 36A. That is, it can be said that the laminate 36A is a layer containing at least Zr.

In the lamination step, as described above, the inert gas G is introduced into the first space SP1 in a state where a vacuum state is made in the first space SP1. The vacuum state here may refer to, for example, setting a pressure to 10 Pa or less, and the same applies hereinafter. In the lamination step, the inert gas G is preferably introduced such that the pressure in the first space SP1 is preferably less than 0.5 Pa, more preferably 0.4 Pa or less, and still more preferably 0.3 Pa or less. That is, in this step, it is preferable to set the pressure in the first space SP1 containing the inert gas G to be in the above range. By setting the first space SP1 to such a pressure, the laminate 36A having a high hardness can be formed, and the scratch resistance can be improved.

Next, the base material 30 on which the laminate 36A is laminated is arranged in a second space SP2 (step S14). An oxygen supply unit M2 is connected to the second space SP2. The oxygen supply unit M2 is a device that supplies oxygen O.

After the base material 30 is arranged in the second space SP2, oxygen plasma (plasma oxygen) is generated in the second space SP2 to oxidize the laminate 36A laminated on the base material 30, thereby forming the outermost layer 36 on the base material 30 (step S16 (oxidation step)). Specifically, in a state where a vacuum state is made in the second space SP2, oxygen O is supplied from the oxygen supply unit M2 into the second space SP2, and oxygen O in the second space SP2 is turned into plasma to generate oxygen plasma. In the second space SP2, the generated oxygen plasma comes into contact with the laminate 36A laminated on the base material 30 and oxidizes the laminate 36A, thereby forming the outermost layer 36 on the base material 30. That is, Zr contained in the laminate 36A is oxidized by oxygen plasma and becomes ZrO₂. It is considered that the hardness is increased because volume expansion of the film occurs in the oxidation process and the film is densified. As a result, the laminate 36A becomes the outermost layer 36 containing ZrO₂ as a main component, and the outermost layer 36 is formed on the base material 30. Not only oxygen plasma but also oxygen radicals and oxygen ions may be generated for oxidation.

The target T contains Zr. In the target T, a content of Zr with respect to the whole target T is preferably 50 atomic % or more and 100 atomic % or less, more preferably 60% atomic or more and 100 atomic % or less, 70 atomic % or more and 100 atomic % or less, or 80 atomic % or more and 100 atomic % or less. As the content of Zr in the target T falls within the range, a volume expansion ratio of the film in the oxidation process can be increased, and the film density is increased, so that the outermost layer 36 having a high hardness can be formed, and the scratch resistance can be improved. The target T may contain ZrO₂ as a component other than Zr.

In the oxidation step, oxygen plasma may be generated by any method, but for example, an electrode may be provided in the second space SP2, and oxygen O in the second space SP2 may be turned into plasma by applying a voltage to the electrode to generate oxygen plasma. In this case, power applied to the electrode is preferably 2 kW or more and 4 kW or less, and more preferably 3 kW or more and 4 kW or less. By setting the applied power within the range, Zr can be appropriately oxidized to form the outermost layer 36 having a high hardness, and the scratch resistance can be improved.

In the present embodiment, the processing from step S10 to step S16 may be repeated to form the outermost layer 36 so as to be gradually thicker.

In the present embodiment, the first space SP1 and the second space SP2 are separate spaces (chambers), and the outermost layer 36 is formed by performing the lamination step and the oxidation step while moving the base material 30 from the first space SP1 to the second space SP2 or from the second space SP2 to the first space SP1. Any method may be used for moving the base material 30 between the first space SP1 and the second space SP2, and for example, the base material 30 may be attached to the surface of a rotatable drum, and the first space SP1 and the second space SP2 may be formed so as to be aligned in a rotation direction of the drum. In this case, as the drum rotates, the base material 30 is moved from the first space SP1 to the second space SP2 (or from the second space SP2 to the first space SP1).

The first space SP1 and the second space SP2 may be the same space (chamber). In this case, sputtering may be performed by applying a voltage to the target T while introducing the inert gas G after a vacuum state is made in a state where the base material 30 is arranged in the space, and then oxygen plasma may be supplied into the space to oxidize the laminate 36A, thereby forming the outermost layer 36.

In the present embodiment, it is preferable to form the outermost layer 36 on the surface of the base material 30 by sputtering under conditions of a predetermined pressure and a predetermined temperature. Here, the predetermined pressure is preferably 0.5 Pa or less, more preferably 0.1 Pa or more and 0.3 Pa or less, and still more preferably 0.15 Pa or more and 0.25 Pa or less. By setting the sputtering conditions in this manner, a refractive index of the outermost layer 36 can be increased, the indentation hardness can be improved, the arithmetic average roughness can be reduced, and the scratch resistance can be more appropriately improved. The predetermined pressure may also be applied when forming an element other than the outermost layer 36.

### Effects

As described above, the far-infrared transmitting member 20 according to the present embodiment includes the base material 30 that transmits far-infrared rays and the first functional film 32 (functional film) formed on the base material 30. The far-infrared transmitting member 20 has an average transmittance of 50% or more with respect to light having a wavelength of 8 μm to 12 μm. The outermost layer 36 of the first functional film 32 is a layer containing ZrO₂ as a main component, a content of ZrO₂ is 50 mass % or more and 100 mass % or less with respect to the whole outermost layer 36, and a refractive index of the outermost layer 36 with respect to light having a wavelength of 550 nm is 2.05 or more.

Here, the far-infrared transmitting member is required to appropriately transmit far-infrared rays and improve the scratch resistance. Since the far-infrared transmitting member 20 according to the present embodiment includes the outermost layer 36 containing ZrO₂ as a main component, far-infrared rays can be appropriately transmitted, and the scratch resistance can be improved. Furthermore, for example, diamond-like carbon (DLC) or the like can also improve the scratch resistance, but a film forming process for DLC is limited, and DLC requires elastic modulus control or the like, and thus, a load in a film forming step increases. On the other hand, by using the outermost layer 36 containing ZrO₂ as a main component as in the present embodiment, it is possible to improve the scratch resistance while reducing the load in the film forming step.

The outermost layer 36 has an extinction coefficient of preferably 0.10 or less with respect to light having a wavelength of 10 μm. As the extinction coefficient of the outermost layer 36 falls within the range, far-infrared rays can be appropriately transmitted.

The thickness D2 of the outermost layer 36 is preferably 20 nm or more. As the thickness D2 of the outermost layer 36 falls within the range, it is possible to improve the scratch resistance while appropriately transmitting far-infrared rays.

The arithmetic average roughness Ra of the surface 36a of the outermost layer 36 is preferably 7.0 nm or less. As the surface roughness falls within the range, the dynamic friction coefficient and the change in surface roughness before and after scratching can be reduced, thereby more appropriately improving the scratch resistance.

The outermost layer 36 has a refractive index of preferably 2.05 or more with respect to light having a wavelength of 550 nm. As the refractive index falls within the range, the film denseness of the outermost layer 36 can be increased, and the scratch resistance can be more appropriately improved. In order to set the refractive index of the outermost layer 36 with respect to light having a wavelength of 550 nm to 2.05 or more, it is effective to increase film formation energy, and specific examples thereof include sputtering in a pressure band of 0.5 Pa or less, short-range sputtering in which a distance between the target and the base material 30 is 100 mm or less, film formation in a high-temperature range of 200° C. or higher, and ion beam processing during film formation.

The far-infrared transmitting member 20 preferably has Δa*b* of 5 or less. As Δa*b* falls within the range, visible light reflected from the far-infrared transmitting member 20 has a neutral color, so that an appearance securing designability can be obtained.

The ratio of the thickness D2 of the outermost layer 36 to the thickness D1 of the base material 30 is preferably 0.002% or more and 0.030% or less. As the thickness D2 falls within such a range, it is possible to improve the scratch resistance while appropriately transmitting far-infrared rays.

The first functional film 32 preferably further includes the intermediate layer 34 provided between the outermost layer 36 and the base material 30. As the intermediate layer 34 is provided, far-infrared rays can be appropriately transmitted.

The intermediate layer 34 preferably includes the antireflection layer. The antireflection layer is a layer containing NiO_{X} as a main component, and a content of NiO_{X} is preferably 50 mass % or more and 100 mass % or less with respect to the whole antireflection layer. By including the antireflection layer containing NiO_{X} as a main component, far-infrared rays can be appropriately transmitted.

The far-infrared transmitting member 20 is preferably mounted on a vehicle. The far-infrared transmitting member 20 is particularly suitable for vehicle applications.

The far-infrared transmitting member 20 is preferably arranged in a window member of a vehicle. The far-infrared transmitting member 20 is particularly suitable for a window member of a vehicle.

The far-infrared transmitting member 20 is preferably arranged in an exterior member for a pillar of a vehicle. The far-infrared transmitting member 20 is particularly suitable for an exterior member for a pillar of a vehicle.

The far-infrared transmitting member 20 is preferably arranged in a light shielding region of a vehicle exterior member. The far-infrared transmitting member 20 is particularly suitable for a vehicle exterior member.

The manufacturing method according to the present embodiment is a method for manufacturing the far-infrared transmitting member 20 in which the first functional film 32 (functional film) is formed on the base material 30 that transmits far-infrared rays, and includes a step of manufacturing the far-infrared transmitting member 20 by forming the outermost layer 36 of the first functional film 32 on the base material 30 by sputtering. The far-infrared transmitting member 20 has an average transmittance of 50% or more with respect to light having a wavelength of 8 μm to 12 μm, the outermost layer 36 is a layer containing ZrO₂ as a main component, a content of ZrO₂ is 50 mass % or more and 100 mass % or less with respect to the whole outermost layer 36, and a refractive index of the outermost layer 36 with respect to light having a wavelength of 550 nm is 2.05 or more. According to the manufacturing method, it is possible to manufacture the far-infrared transmitting member 20 capable of improving the scratch resistance while appropriately transmitting far-infrared rays.

In a step of forming the outermost layer 36, it is preferable to perform sputtering under a pressure of 0.30 Pa or less. By performing sputtering under such a low pressure, the outermost layer 36 having excellent scratch resistance can be formed.

The sputtering is preferably performed using the post-oxidation sputtering method. The outermost layer 36 having excellent scratch resistance can be formed by performing post-oxidation sputtering.

### EXAMPLES

Hereinafter, the present invention will be specifically described with reference to examples, but the present invention is not limited thereto. Tables 1 and 2 are tables showing the far-infrared transmitting members of the examples.

TABLE 1

| | | Example | Example | Example | Example | Example | Example | Example | Example | Example | Example |
|---|---|---|---|---|---|---|---|---|---|---|---|
| | | 1 | 2 | 3 | 4 | 5 | 6 | 7 | 8 | 9 | 10 |
| Film 4 | Film type | ZrO₂ | | | | | | | | | |
| | Film thickness | 200 | | | | | | | | | |
| | nm | | | | | | | | | | |
| Film 3 | Film type | NiO | | | | | | | | | |
| | Film thickness | 15 | | | | | | | | | |
| | nm | | | | | | | | | | |
| Film 2 | Film type | ZrO₂ | ZrO₂ | ZrO₂ | | | | ZnO | SiO₂ | Al₂O₃ | Si |
| | Film thickness | 25 | 200 | 200 | | | | 200 | 200 | 200 | 200 |
| | nm | | | | | | | | | | |
| Film 1 | Film type | NiO | NiO | ZnO | ZrO₂ | ZnO | NiO | NiO | NiO | NiO | NiO |
| | Film thickness | 1050 | 1050 | 1050 | 1250 | 1250 | 1250 | 1050 | 1050 | 1050 | 1050 |
| | nm | | | | | | | | | | |
| Base | Material | Si | Si | Si | Si | Si | Si | Si | Si | Si | Si |
| material | Thickness mm | 2 | 2 | 2 | 2 | 2 | 2 | 2 | 2 | 2 | 2 |
| Process | Sputtering | Post- | Reactive sputtering | | | | | | | | |
| condition | method | oxidation | | | | | | | | | |
| | | sputtering | | | | | | | | | |
| | Film formation | 0.21 | 0.24 | 0.24 | 0.24 | 0.24 | 0.30 | 0.24 | 0.28 | 0.24 | 0.27 |
| | pressure (Pa) | | | | | | | | | | |
| | Outermost layer | 2.22 | 2.16 | 2.16 | 2.16 | 2.00 | 2.33 | 2.00 | 1.46 | 1.67 | 4.06 |
| | refractive index | | | | | | | | | | |
| | Ra nm | 2.64 | 3.89 | 2.00 | 7.84 | 2.87 | 7.91 | 3.55 | 3.14 | 1.51 | 4.32 |
| | Indentation | 13.5 | 10.0 | 11.1 | 8.5 | 10.7 | 6.8 | 9.2 | 6.1 | 11.2 | 7.3 |
| | hardness (GPa) | | | | | | | | | | |
| | FIR-T% | 69.2 | 69.3 | 68.6 | 64.7 | 68.7 | 70.3 | 69.4 | 42.3 | 66.7 | 54.1 |
| | Δa*b* | 1.7 | 10.7 | 2.5 | 3.8 | 2.9 | 0.1 | 25.0 | 44.9 | 46.4 | 3.6 |
| Evaluation | Number of | 0 | 2 | 0 | 1 | 206 | 13 | 68 | 112 | 55 | 102 |
| result | scratches in | | | | | | | | | | |
| | wiper test | | | | | | | | | | |
| | Color change | None | None | None | Changed | Changed | Changed | Changed | None | Changed | None |
| | Boiling test | OK | OK | OK | OK | OK | OK | NG | OK | OK | NG |

TABLE 2

| | | Example | Example | Example | Example | Example |
|---|---|---|---|---|---|---|
| | | 11 | 12 | 2 | 13 | 14 |
| Film 4 | Film type | | | | | |
| | Film | | | | | |
| | thickness | | | | | |
| | nm | | | | | |
| Film 3 | Film type | | | | | |
| | Film | | | | | |
| | thickness | | | | | |
| | nm | | | | | |
| Film 2 | Film type | ZrO₂ | ZrO₂ | ZrO₂ | ZrO₂ | ZrO₂ |
| | Film | 20 | 100 | 200 | 200 | 200 |
| | thickness | | | | | |
| | nm | | | | | |
| Film 1 | Film type | NiO | NiO | NiO | NiO | NiO |
| | Film | 1150 | 1150 | 1150 | 1150 | 1150 |
| | thickness | | | | | |
| | nm | | | | | |
| Base | Material | Si | Si | Si | Si | Si |
| material | Thickness | 2 | 2 | 2 | 2 | 2 |
| | mm | | | | | |
| Process | Sputtering | Reactive sputtering | | | | Post- |
| condition | method | | | | | oxidation |
| | | | | | | sputtering |
| | Film | 0.24 | 0.24 | 0.24 | 0.84 | 0.21 |
| | formation | | | | | |
| | pressure (Pa) | | | | | |
| Physical | Outermost | 2.16 | 2.16 | 2.16 | 2.04 | 2.22 |
| property | layer | | | | | |
| value | refractive | | | | | |
| | index | | | | | |
| | Ra nm | 7.3 | 4.3 | 3.9 | 4.4 | 3.0 |
| | Indentation | 7.1 | 7.6 | 10.0 | 7.3 | 12.5 |
| | hardness | | | | | |
| | (GPa) | | | | | |
| | FIR-T % | 70.7 | 70.2 | 69.3 | 70.0 | 68.6 |
| Eval- | Number of | 2 | 3 | 2 | 16 | 0 |
| uation | scratches in | | | | | |
| result | wiper test | | | | | |
| | Color | Changed | None | None | Changed | None |
| | change | | | | | |

### Example 1

As shown in Table 1, in Example 1, the NiOₓ film as the intermediate layer, the ZrO₂ film, and the NiOₓ film were formed in this order on the base material made of Si (FZ grade) by the post-oxidation sputtering method using a load-lock type sputtering system (RAS-1100BII manufactured by SHINCRON CO., LTD.), and the ZrO₂, film as the outermost layer was formed on a surface farthest from the base material. The thicknesses of the base material, the NiOₓ film, and the ZrO₂, film were as shown in Table 1. The thickness of the base material was measured with a digital caliper (CD-15CX manufactured by Mitutoyo Corporation). The thickness of the functional film was evaluated by a stylus profiling system (Dektak XT-S manufactured by Bruker Corporation).

The film formation conditions for the NiOₓ film and the ZrO₂ film are as follows. A part of the film forming conditions (a sputtering method and a film forming pressure) is described in Table 1.

### (NiOₓ Film Formation Conditions)

Target: NiO (70 mass %)+Ni (30 mass %) mixed target
Sputtering gas: Ar gas (flow rate: 150 sccm)
Input power: 6 kW
Reactive gas: Ar (flow rate: 70 sccm)+O₂ (flow rate: 10 sccm)
RF power: 2 kW
Substrate temperature: normal temperature
Film formation pressure: 0.20 Pa

### (ZrO₂ Film Formation Conditions)

Target: Zr target
Sputtering gas: Ar gas (flow rate: 150 sccm)
Input power: 6 kW
Reactive gas: O₂ (flow rate: 100 sccm)
RF power: 4 kW
Substrate temperature: room temperature
Film formation pressure: 0.21 Pa

### Example 2

As shown in Table 1, in Example 2, the NiOₓ film as the intermediate layer and the ZrO₂ film as the outermost layer were formed in this order on the base material made of Si (FZ grade) by the reactive sputtering method using a carousel type sputtering system. The far-infrared transmitting member was obtained in the same manner as in Example 1 except that thicknesses of the base material, the NiOₓ film, and the ZrO₂ film were as shown in Table 1.

The film formation conditions for the NiOₓ film and the ZrO₂ film are as follows. The film formation pressure was adjusted by an APC valve opening degree of a turbo molecular pump.

### (Film Formation Conditions for NiOₓ Film)

Target: NiO (70 mass %)+Ni (30 mass %) mixed target
Sputtering gas: Ar gas (flow rate: 120 sccm)
Reactive gas: O₂ (flow rate: 30 sccm)
Input power: 3000 W
Substrate temperature: room temperature
Film formation pressure: 0.30 Pa

### (Film Formation Conditions for ZrO₂ Film)

Target: Zr target
Sputtering gas: Ar gas (flow rate: 100 sccm)
Reactive gas: O₂ (flow rate: 50 sccm)
Input power: 3 kW
Substrate temperature: room temperature
Film formation pressure: 0.24 Pa

### Example 3 to Example 12

In Examples 3 to 12, the far-infrared transmitting member was obtained in the same manner as in Example 2 except that the material and the thickness of the film were changed from those in Example 2 as shown in Tables 1 and 2. The film formation conditions for the ZnO film, the SiO₂ film, the Al₂O₃ film, and the Si film are as follows.

### (Film Formation Conditions for ZnO Film)

Target: Zn target
Sputtering gas: Ar gas (flow rate: 100 sccm)
Reactive gas: O₂ (flow rate: 100 sccm)
Input power: 3000 W
Substrate temperature: room temperature
Film formation pressure: 0.24 Pa

### (Film Formation Conditions for SiO₂ Film)

Target: Si target
Sputtering gas: Ar gas (flow rate: 100 sccm)
Reactive gas: O₂ (flow rate: 100 sccm)
Input power: 3000 W
Substrate temperature: room temperature
Film formation pressure: 0.28 Pa
   (Film Formation Conditions for Al₂O₃ Film)
Target: Al target
Sputtering gas: Ar gas (flow rate: 100 sccm)
Reactive gas: O₂ (flow rate: 100 sccm)
Input power: 3000 W
Substrate temperature: room temperature
Film formation pressure: 0.24 Pa

### (Film Formation Conditions for Si Film)

Target: Si target
Sputtering gas: Ar gas (flow rate: 200 sccm)
Reactive gas: None
Input power: 3000 W
Substrate temperature: room temperature
Film formation pressure: 0.27 Pa

### Example 13

In Example 13, the far-infrared transmitting member was obtained in the same manner as in Example 2 except that the thickness of the NiOₓ film and the film formation conditions for the ZrO₂ film were changed from those in Example 2 as shown in Table 2. The film formation conditions for the ZrO₂ film are as follows.

### (Film Formation Conditions for ZrO₂ Film)

Target: Zr target
Sputtering gas: Ar gas (flow rate: 100 sccm)
Reactive gas: O₂ (flow rate: 50 sccm)
Input power: 3000 W
Substrate temperature: room temperature
Film formation pressure: 0.84 Pa

### Example 14

In Example 14, the far-infrared transmitting member was obtained in the same manner as in Example 1 except that the composition of the intermediate layer was changed from that in Example 1 as shown in Table 2.

### (Outermost Layer Refractive Index)

Physical property values of the far-infrared transmitting member of each example were measured.

As the physical property value, a refractive index of a film on a side (outermost side) farthest from the base material of the far-infrared transmitting member with respect to light having a wavelength of 550 nm was evaluated. The refractive index was determined by performing fitting of an optical model using polarization information obtained by a spectroscopic ellipsometer (M-2000 manufactured by J.A. Woollam) and a spectral transmittance measured based on JIS R3106.

The film on the side (outermost side) farthest from the base material refers to the outermost layer, for example, Film 4 in Example 1 and Film 2 in Example 2.

### (Arithmetic Average Roughness Ra)

As the physical property value, the arithmetic average roughness Ra of a surface of the far-infrared transmitting member on the side (outermost side) farthest from the base material was measured based on JIS B0601. The surface on the side (outermost side) farthest from the base material refers to, for example, a surface of Film 4 in Example 1, and refers to a surface of Film 2 in Example 2.

### (Indentation Hardness)

As the physical property value, an indentation hardness of the first functional film in a film thickness direction (depth direction) was measured by the nanoindentation method using the iMicro nanoindenter (manufactured by KLA). The measurement conditions are as follows.
Indenter: Berkovich
Actuator: IF50
Measurement method: Continuous stiffness measurement method
Maximum indentation load: 50 mN
Strain rate: 0.2%/s
Poisson's ratio of sample: 0.25
Number of points measured: 15 to 20 points per substrate

An average indentation hardness value at an indentation depth of 108 nm was adopted as a representative value. In order to minimize an influence of the substrate, it is recommended to perform evaluation at an indentation depth of 1/10 or less of an evaluation film thickness.

### (Average Transmittance for Light Having Wavelength of 8 μm to 12 μm)

As the physical property value, an average transmittance (FIR-T) for light having a wavelength of 8 μm to 12 μm was measured. As a measurement method, a transmittance for light having each wavelength of 8 μm to 12 μm was measured using a Fourier transform infrared spectrometer (product name: Nicolet iS10 manufactured by ThermoScientific), and the average transmittance was calculated from the measured transmittances.

(Δa*b*)

As the physical property value, Δa*b* was measured. A reflection spectrum in a visible range was measured using U4100 (manufactured by Hitachi, Ltd.) based on JIS R3106, chromaticity coordinates L*a*b* of reflected light in the CIE-Lab color coordinate system when the standard illuminant D65 was used for illumination light was obtained based on JIS Z 8781-4, and Δa*b* was calculated based on Equation (3) above.

The results of measuring the physical property values of each example are shown in Tables 1 and 2.

### (Evaluation)

The far-infrared transmitting member of each example was evaluated. As the evaluation, a wiper test was conducted, and the number of scratches formed in the wiper test was measured. Specifically, the wiper test was conducted on the surface on the side (outermost side) farthest from the base material under the following conditions, and then a dark-field observation was performed at a magnification of 350 using an optical microscope DSX500 (manufactured by Olympus Corporation) at a sliding portion where a wiper was slid. In the dark-field observation, the number of scratches in a region having a dimension of 1.8 mm in a direction perpendicular to a sliding direction was measured.

The wiper test was conducted using a traverse type abrasion tester by abrading the surface on the side (outermost side) farthest from the base material under the following test conditions. A wiper rubber (Toyota genuine product whose model number is 85214-47170) was mounted on the traverse type abrasion tester, a dust solution was dropped between the wiper and the sample, and reciprocating friction was applied while applying a contact load to the wiper. A wiper width was 20 mm, a stroke width was 40 mm, the number of strokes was 2500 cycles, and the load was equivalent to 50 g. The dust solution was prepared by mixing eight types of JIS test powder 1 and pure water at a mass ratio of 3:100, and 2 ml of the dust solution was dropped to the sliding portion. The substrate was cleaned every 500 cycles, and the dust solution was dropped again to apply reciprocating friction of 2500 cycles in total.

When the number of scratches in the wiper test was five or less, it was regarded as pass, and when the number of scratches was more than five, it was regarded as fail. As shown in Table 1, in Examples 1 to 4, 11, 12, and 14 corresponding to Examples in which the outermost layer is a film containing ZrO₂ as a main component and the refractive index of the outermost layer with respect to light having a wavelength of 550 nm is 2.05 or more, the wiper test was passed, and it can be seen that it is possible to improve the scratch resistance while appropriately transmitting far-infrared rays. On the other hand, in Examples 5 to 10 and 13 corresponding to comparative examples, the wiper test failed due to a low mechanical strength, and it is presumed that it is not possible to improve the scratch resistance while appropriately transmitting far-infrared rays. In Examples 5, 7, and 9 corresponding to comparative examples, it can be seen that a high indentation hardness of 8.0 GPa or more is obtained, but the wiper scratch resistance is low. It is presumed that this is because a film type having a low resistance to adhesion abrasion and chemical abrasion in a mixed system of water and dust was used. From the above results, it can be said that a ZrO₂ film having a high chemical stability and a high indentation hardness is suitable as the outermost layer. In Example 13 corresponding to a comparative example, since the film formation pressure of the ZrO₂ film is high and the refractive index of the ZrO₂ film with respect to light having a wavelength of 550 nm is less than 2.05, the wiper test failed, and it is presumed that it is not possible to improve the scratch resistance while appropriately transmitting far-infrared rays.

### (Option Evaluation)

As optional evaluation, color change evaluation and a boiling test were performed.

In the color change evaluation, the surface farthest from the base material after conducting the wiper test was visually observed to confirm whether or not a color change occurred in the entire abraded portion. In a case where the color change occurred, it is considered that minute abrasion of the film or a change in surface roughness occurred, and thus it is more preferable that the color change does not occur. As shown in Table 2, it can be seen by comparing Example 11 with Examples 2, 12, and 14 that when the arithmetic average roughness Ra of the surface is small, the color change does not occur, and the scratch resistance can be more suitably improved.

In addition, the boiling test was conducted according to JIS R3212, and the sample of each example was held in pure water at 100° C.±2° C. for two hours. A sample in which film peeling occurred after the boiling test or a sample in which an average transmittance change for 8 μm to 12 μm occurred by 5% or more after the boiling test were determined to be failed. By using a film containing ZrO₂ as a main component as the outermost layer as in Examples 1, 2, and 11 to 14 corresponding to examples, the boiling test can be passed, and water resistance performance can be improved, which is more preferable.

Although the embodiments of the present invention have been described above, the embodiments are not limited by the contents of the embodiments. In addition, the above-described constituent elements include those that can be easily assumed by those skilled in the art, those that are substantially the same, and those in a so-called equivalent scope. Furthermore, the above-described constituent elements can be appropriately combined. Furthermore, various omissions, substitutions, or changes of the constituent elements can be made without departing from the gist of the above-described embodiments.

### REFERENCE SIGNS LIST

1 VEHICLE GLASS
10, 12, 14 GLASS SUBSTRATE
20 FAR-INFRARED TRANSMITTING MEMBER
30 BASE MATERIAL
32 FIRST FUNCTIONAL FILM (FUNCTIONAL FILM)
34 INTERMEDIATE LAYER
36 OUTERMOST LAYER
38 SECOND FUNCTIONAL FILM

1. A far-infrared transmitting member comprising:
a base material that transmits far-infrared rays; and a functional film formed on the base material, wherein
an average transmittance for light having a wavelength of 8 μm to 12 μm is 50% or more, and
an outermost layer of the functional film is a layer containing ZrO₂ as a main component, a content of ZrO₂ is 50 mass % or more and 100 mass % or less with respect to the whole outermost layer, and a refractive index of the outermost layer with respect to light having a wavelength of 550 nm is 2.05 or more.

2. The far-infrared transmitting member according to claim 1, wherein the outermost layer has an extinction coefficient of 0.10 or less with respect to light having a wavelength of 10 μm.

3. The far-infrared transmitting member according to claim 1, wherein a thickness of the outermost layer is 20 nm or more.

4. The far-infrared transmitting member according to claim 1, wherein a surface of the outermost layer has an arithmetic average roughness Ra of 7.0 nm or less.

5. The far-infrared transmitting member according to claim 1, wherein a value of Δa*b* is 5 or less, Δa*b* being defined by Equation (3):
Δa*b*=(a*²+b*²)^{0.5} (3)
in which a* and b* represent chromaticity coordinates of reflected light in a CIE-Lab color system when a standard illuminant D65 is used for illumination light, and are calculated based on JIS Z 8781-4 using a spectral reflectance measured based on JIS R3106.

6. The far-infrared transmitting member according to claim 1, wherein a ratio of a thickness of the outermost layer to a thickness of the base material of the far-infrared transmitting member is 0.002% or more and 0.030% or less.

7. The far-infrared transmitting member according to claim 1, wherein the functional film further includes an intermediate layer provided between the outermost layer and the base material.

8. The far-infrared transmitting member according to claim 7, wherein the intermediate layer includes an antireflection layer containing NiO_{X} as a main component, and a content of NiO_{X} is 50 mass % or more and 100 masse or less with respect to the whole antireflection layer.

9. The far-infrared transmitting member according to claim 1, wherein the far-infrared transmitting member is mounted on a vehicle.

10. The far-infrared transmitting member according to claim 9, wherein the far-infrared transmitting member is arranged in a window member of the vehicle.

11. The far-infrared transmitting member according to claim 9, wherein the far-infrared transmitting member is arranged in an exterior member for a pillar of the vehicle.

12. The far-infrared transmitting member according to claim 9, wherein the far-infrared transmitting member is arranged in a light shielding region of a vehicle exterior member.

13. A method for manufacturing a far-infrared transmitting member in which a functional film is formed on a base material that transmits far-infrared rays, the method comprising:
forming an outermost layer of the functional film on the base material by sputtering to manufacture the far-infrared transmitting member, wherein
the far-infrared transmitting member has an average transmittance of 50% or more with respect to light having a wavelength of 8 μm to 12 μm, and
the outermost layer is a layer containing ZrO₂ as a main component, a content of ZrO₂ is 50 mass % or more and 100 mass % or less with respect to the whole outermost layer, and a refractive index of the outermost layer with respect to light having a wavelength of 550 nm is 2.05 or more.

14. The method for manufacturing a far-infrared transmitting member according to claim 13, wherein in the forming of the outermost layer, the sputtering is performed under a pressure of 0.30 Pa or less.

15. The method for manufacturing a far-infrared transmitting member according to claim 13, wherein the sputtering is performed using a post-oxidation sputtering method.
